(19) United States
(12) Patent Application Publication
(10) Pub. No.: US 2009/0300383 A1
(43) Pub. Date: Dec. 3, 2009

(54) ENERGY CONSERVATION CONTROL DEVICE FOR A NETWORK SYSTEM

(76) Inventor: Masahiko KANEKO, Hadano (JP)

Correspondence Address: BRUNDIDGE & STANGER, P.C., 1700 DIAGONAL ROAD, SUITE 330, ALEXANDRIA, VA, 22314, US

(21) Appl. No.: 12/393,159

(22) Filed: Feb. 26, 2009

(30) Foreign Application Priority Data
May 28, 2008 (JP) 2008-138857

(51) Int. Cl. G06F 1/32

(52) U.S. Cl. 713/310; 713/320

(57) ABSTRACT

In order to accomplish the aforementioned task, there is characterized an electric power consumption control method, for a plurality of network connection devices connected with the network, which groups a plurality of network connection devices and, on the basis of the traffic level of the grouped network connection devices, controls the grouped network connection devices in group units.

### INCORPORATION BY REFERENCE

The present application claims priority from Japanese application JP2008-138857 filed on May 28, 2008, the content of which is hereby incorporated by reference into this application.

### BACKGROUND OF THE INVENTION

1. Field of the Invention

The present invention is concerned with a control method, and the like, for network connection devices constituting a network system and pertains in particular to an electric power consumption control device capable of effectively reducing the electric power consumption of an entire network system.

2. Description of the Related Art

Taking as an example a standard network in a current medium-sized enterprise, if one makes a tentative calculation of the energy consumption thereof in the case where several hundreds of terminals such as Personal Computers (PCs) are connected, the configuration thereof becomes roughly like in FIG. 1, the equipment configuration working out to two core switches and on the order of ten edge switches.

As for this equipment configuration, duplication is configured with a core switch A 102 and a core switch B 103, connected with a server 101, and wires are connected respectively from each core switch to the edge switches under its command. Further, there are connected clusters of client PCs under the command of edge switches 104 to 106. In a normal operating state, core switch 102 is in an operating state and core switch 103 is in a standby state, communication from e.g. a client PC cluster 107 to server 101 being carried out along the path from client cluster 107 to edge switch 104, core switch 102, and server 101.

The annual electric power consumption with this equipment configuration works out to approximately 25,000 kWh. As for this figure, there is the concern that, accompanying the increase in future communication traffic, it will rise increasingly. Also, seen from the perspective of a reduction in the amount of electric power consumption, the level of dependence on today's information communication technology and the communication traffic flowing in a corporate network accompanying the same exhibit exponential growth that is continuing. For this reason, the electric power consumed by the routers and network connection devices such as LAN (Local Area Network) switches is also almost attaining a level which cannot be disregarded.

Moreover, in JP-A-2005-198312, there is proposed a method in which, as a response to a request for a reduction in the level of electric power consumption, there is, regarding the determination of the routing path in the prior art such as of e.g. a wireless communication system, not only taken into account concepts pertaining to the distance between each of the network connection devices, but the electric power needed for data transfer between the network connection devices constituting the wireless communication system is measured and a path is used for which the energy consumption needed to transmit data all the way to the connection devices of the transmitting network and the connection devices of the destination network becomes a minimum.

### SUMMARY OF THE INVENTION

Since network connection devices in a wireless network move, and since the electric power needed for data transfer between the network connection devices fluctuates, it is valid to select the route for which the electric power consumption is at a minimum, but as far as wireline networks are concerned, since the positions of the network connection devices are fixed, route variations for carrying out communication are static, so the electric power needed for data transfer between the network connection devices also becomes fixed. As a result, as far as wireline networks are concerned, the effect of reducing electric power consumption with the method in the aforementioned JP-A-2005-198312 is small.

Moreover, there is not taken into account any local electric power consumption reduction method corresponding to the fact that the number of users of e.g. a company department unit or building floor unit network within a network system diminishes. Also, there is not taken into account any electric power consumption reduction method corresponding to carrying out electric power conservation operations in a planned way during time slots in which the number of network users diminishes, such as at night or during holidays. Further, it is not taken into account that it is possible for peripheral network equipment to also similarly switch to electric power conservation operation (electric power conservation mode) due to the fact that, with an equipment unit “electric power conservation operation function”, the concerned equipment switches to electric power conservation operation.

It is an object of the present invention to furnish an energy conservation control method capable of effectively reducing the electric power consumption of an entire network system by adapting to the situation of utilization or the utilization time slot.

There is used a monitoring device connected with a plurality of network devices, administering the aforementioned plurality of network devices by group, monitoring the level of communication traffic for each group, and having a group-specific mode instruction part emitting, in units of the aforementioned groups, group-specific mode instructions to switch to an electric power conservation mode, to the aforementioned network devices.

According to the present invention, it is possible, by grouping a plurality of network connection devices constituting a communication network system, to strive for a reduction in electric power consumption in units of independent groups, without regard to the network utilization situation of other groups, and also, judgments as to whether electric power conservation operation by hand is possible or not, and the accompanying labor of setting network connection devices, are reduced.

### BRIEF DESCRIPTION OF THE DRAWINGS

FIG. 1 is an example of a block diagram of a standard office network.

FIG. 2 is an example of a model diagram of a communication network system controlled with a network monitoring device 201.

FIG. 3 is an example of a network tree model diagram of a communication network system controlled with a network monitoring device 301.

FIG. 4 is an example of a block diagram of network monitoring server 301.

FIG. 5 is an example of a network tree table 412.

FIG. 6 is an example of a business operation subdivision information table 403.

FIG. 7 is an example of a group-internal host information table 404.

FIG. 8 is an example of a group table 406.

FIG. 9 is an example of a traffic level table 409 for each group table.

FIG. 10 is an example of a time-of-day fixed instruction information table 410.

FIG. 11 is an example of a flowchart up to the point where a mode switching instruction is emitted by network monitoring server 301.

FIGS. 12A and 12B are examples of flowcharts up to the point where a mode switching instruction is emitted by network monitoring server 301.

FIG. 13 is an example of a display screen display based on input and output part 413.

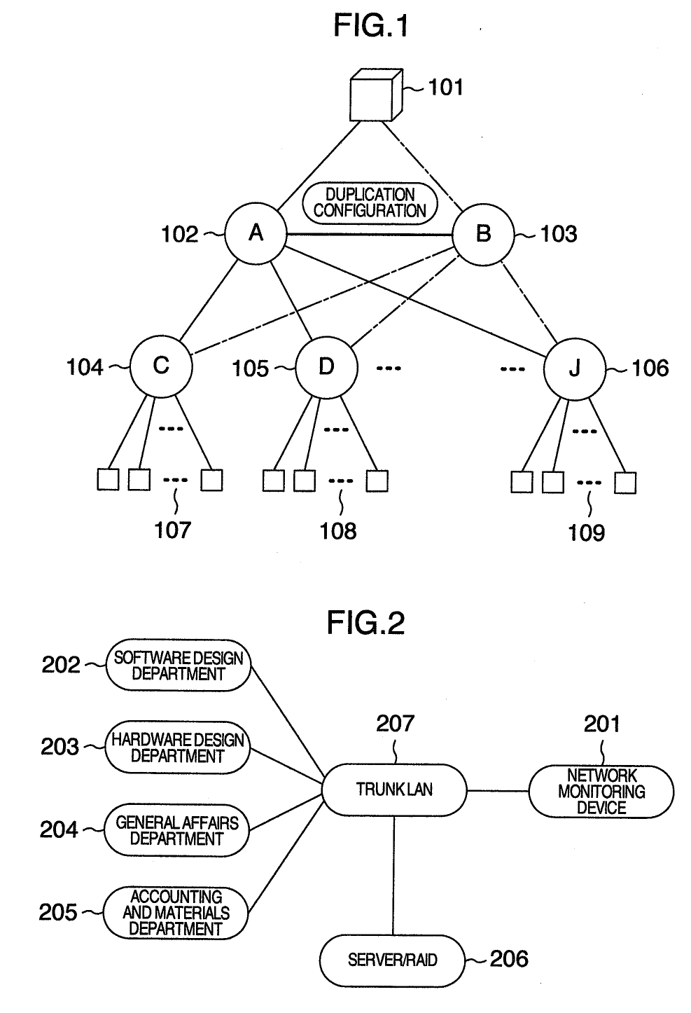

### DESCRIPTION OF THE EMBODIMENTS

Hereinafter, a description will be given of the present invention with reference to the drawings.

The system of the present invention monitors an entire network by means of a network monitoring device and enables a switch to “electric power conservation operation” with respect to a plurality of network connection devices connected with the network. The expression “electric power conservation operation” here refers to turning off the power supply of unused ports and line interfaces in the network equipment, or alternatively, it is the function of lowering the frequency of the internal operating clock, or the like, to lower the electric power conservation, in case there is surplus power with respect to the communication traffic.

In FIG. 2, there is shown a model diagram of the network configuration of Company A, which is an embodiment of a communication network system related to the present invention. As for the network system of Company A, a network monitoring device 201 monitoring the entire system and a software design department 202, a hardware design department 203, a general affairs department 204, an accounting and materials department 205, and a server/RAID (Redundant Array of Independent Disks) 206, indicating the network configuration of each department of Company A, are connected by means of a trunk LAN 207. Network monitoring device 201 is constituted by one or several network monitoring servers. The trunk LAN and the configuration of the network of each department are also constituted by one or several network connection devices.

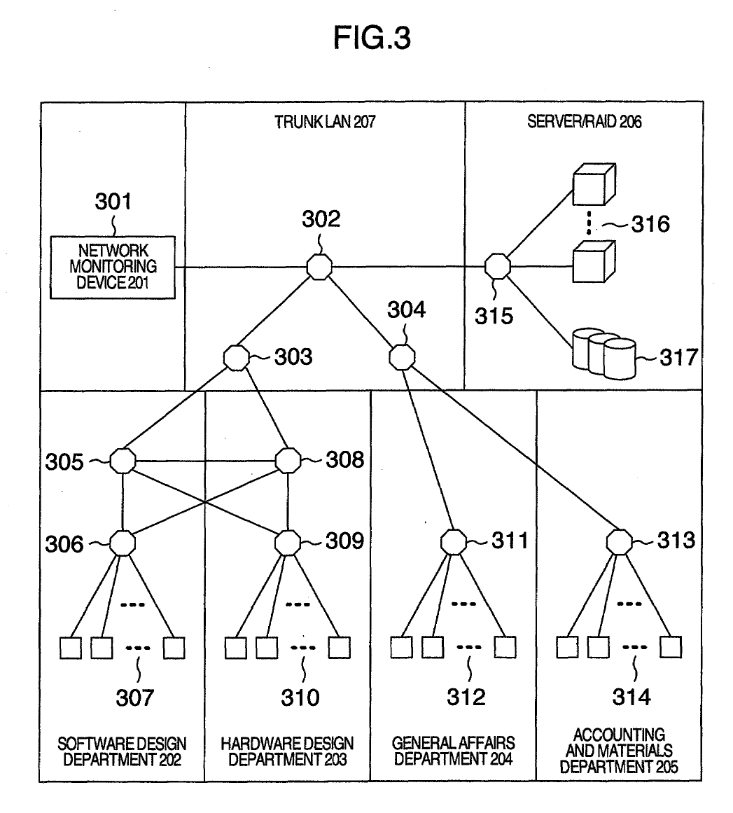

In FIG. 3, there is shown a specific configuration of the network system of Company A. The regions delimited by dash and dot lines inside the diagram indicate respective departments, the pieces of equipment existing inside the same regions being equipment utilized in the departments indicated by the same regions. E.g., inside the region of general affairs department 204, there exist a network connection device 311 and a client cluster 312. This indicates that network monitoring device 311 and client cluster 312 are utilized in the business operations of general affairs department 204. Below are the network configurations of each department. Network monitoring device 201 consists of one network monitoring server 301 and trunk LAN 207 is constituted by one network monitoring device 302, a network connection device 303, and a network connection device 304. Software design department 202 consists of a network monitoring device 305, a network monitoring device 306, and a client cluster 307. Hardware design department 203 consists of a network connection device 308, a network connection device 309, and a client cluster 310. General affairs department 204 consists of a network connection device 311 and a client cluster 312. Accounting and materials department 205 consists of network connection device 313 and a client cluster 314. Server/RAID 206 consists of a network connection device 315, a server cluster 316 and a RAID cluster 317. Each piece of equipment is connected by means of the LAN.

Also, it is assumed that a host name which is the same as the reference numeral is assigned to each of the network connection devices. E.g., in the case of network connection device 302, the host name is “302”. Host names correspond to IP addresses, so network monitoring server 301 is able, by designating a host name, to communicate with each piece of equipment. Host names are e.g. defined by URLs (Uniform Resource Locators) or the like.

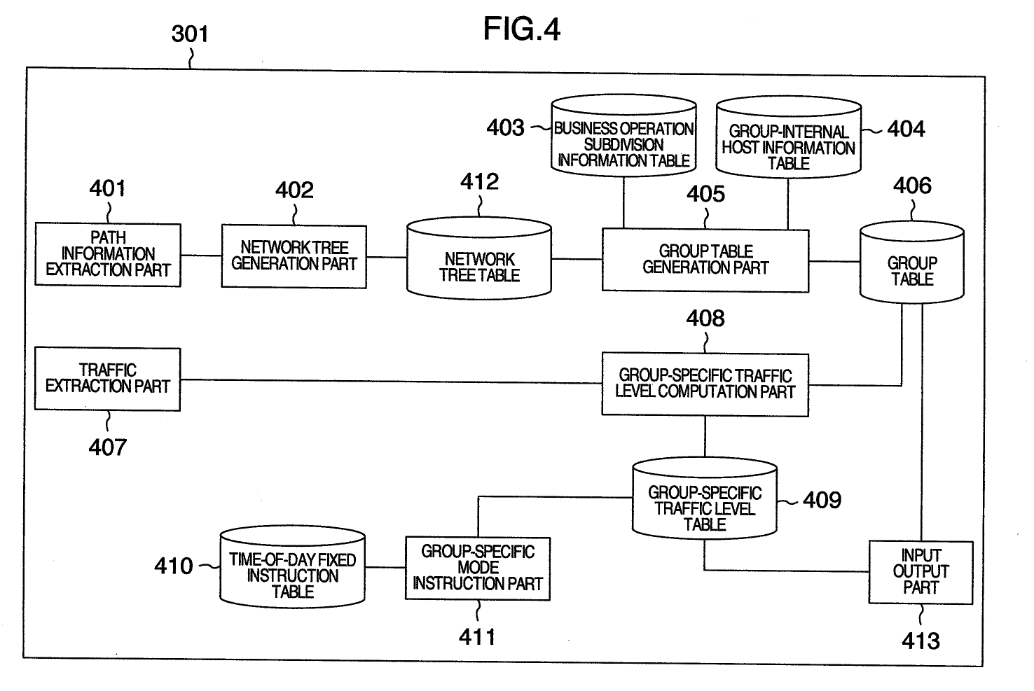

In FIG. 4, the configuration of network monitoring server 301 is shown. Network monitoring server 301 consists of: a path information extraction part 401 collecting path information about the network connection devices under administration; a network tree generation part 402 generating a network tree table from the collected path information; a generated network tree table 412; a business operation subdivision information table 403 storing the correspondences between group IDs utilized on the occasion of grouping the network connection devices and business operation subdivisions; a group-internal host information table 404 storing the range of host IP addresses to be stored for each group; a group table generation part 405 generating a group table 406 storing the correspondences of groups and hosts; the generated group table 406; a traffic extraction part 407 extracting the traffic of network connection devices under administration; a group-specific traffic level computation part 408 computing the extracted traffic total for each group; an extracted group-specific traffic level table 409; a time-of-day fixed instruction table 410; a group-specific mode instruction part 411; and an input output part 413 visually representing the state of the network system from group table 406 and group-specific traffic level table 409 and receiving inputs from the administrator.

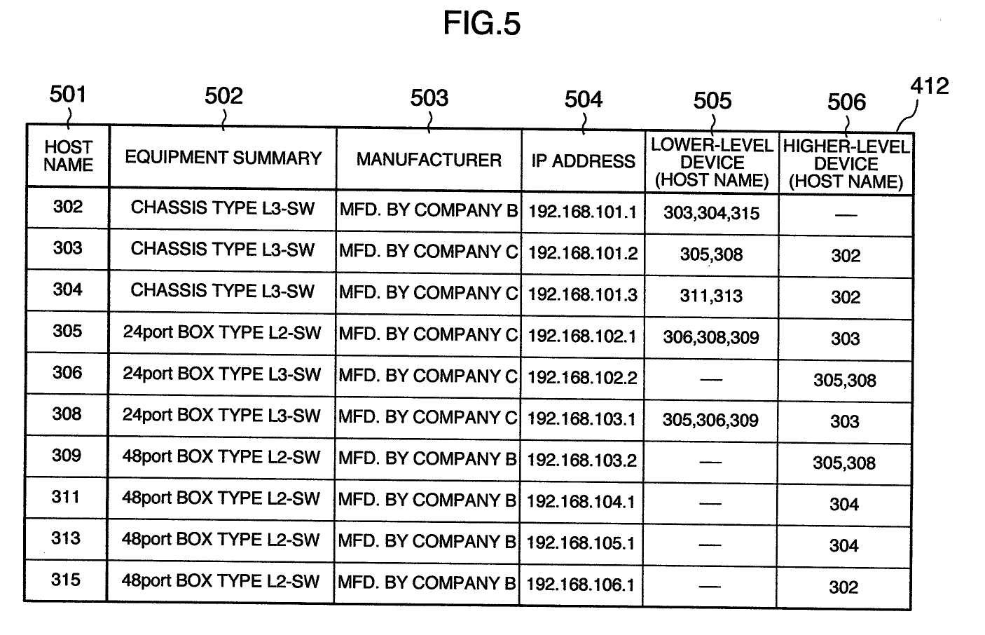

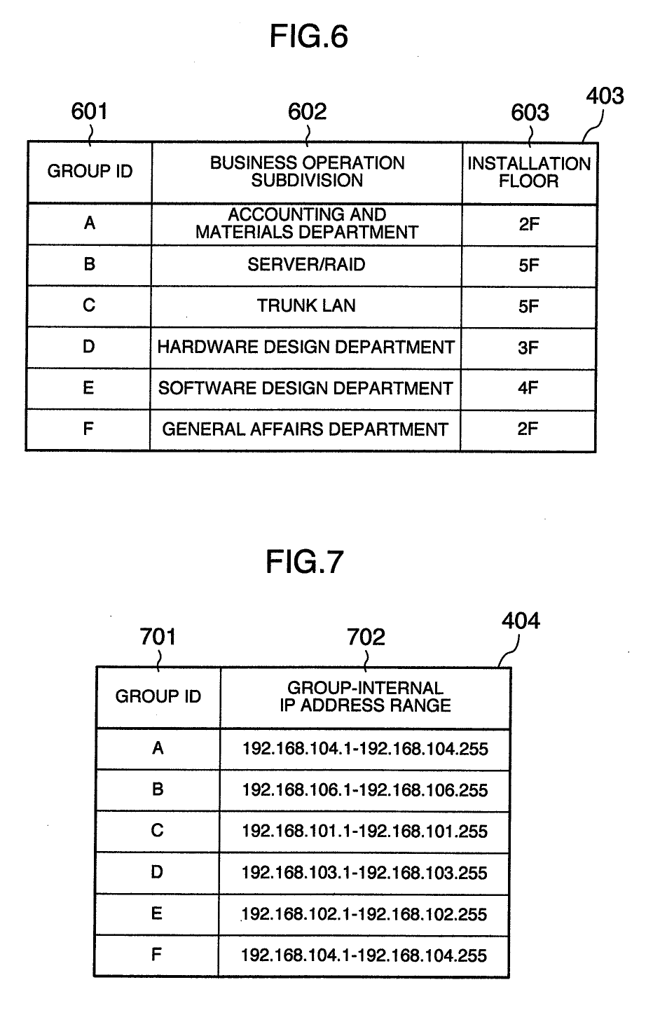

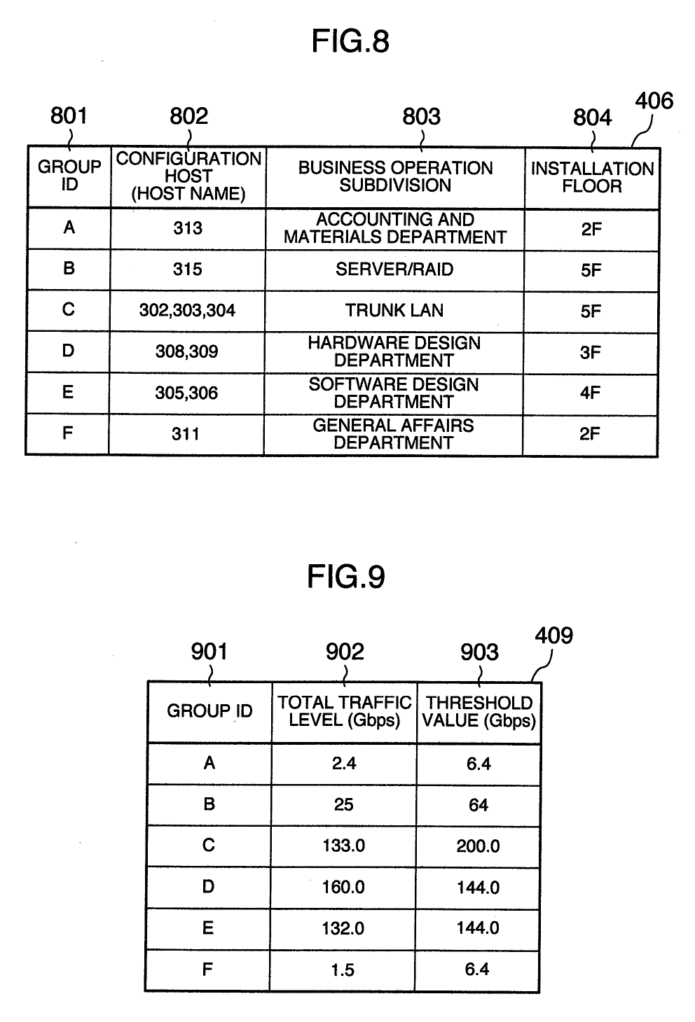

In monitoring server 301, there is first collected path information from the network connection devices with which path information extraction part 401 is connected by LAN with SNMP (Simple Network Management Protocol). In the path information, there are included IP addresses of the network connection devices, the upstream and downstream connection relationships of each network connection device, and other information regarding the network connection devices. Next, a network tree table 412 shown in FIG. 5 is generated from the path information collected by network tree generation part 402. Further, network tree table 412 shown in FIG. 5 becomes a table representing the network tree of Company A shown in FIG. 3. Next, group table 406 shown in FIG. 8 is generated by group table generation part 405 from network tree table 412, business operation subdivision information table 403 shown in FIG. 6, and group-internal host information table 404 shown in FIG. 7. Group table 406 is a table of each network connection device administered for each business operation such as software design department 202 or general affairs department 204, or for each floor. The processing this far is devised so that monitoring server 301 can administer each network connection device of Company A in business operation units, floor units, or the like.

Next, traffic collection part 407 collects, from each network connection device within the network, the level of traffic within the network connection device with a flow statistics protocol. As a flow statistics protocol, sFlow® or NetFlow® may be used. Next, group-specific traffic level table 409 is generated from information pertaining to the traffic level collected by group-specific traffic computation part 408 and group table 406. Next, group-specific mode instruction part 411 consults group-specific traffic level table 409 and time-of-day fixed instruction table 410 and emits an instruction, such as a switch to an electric power conservation mode, to the network connection devices, for each group unit. A description of the detailed operation will be given subsequently. Also, as for time-of-day fixed instruction table 410, there are stored instructions as to how the network connection devices within each group are to be operated, by means of the conditions time of day, day of week, and traffic level.

Further, in the present embodiment, one network monitoring server has all the functions necessary for the monitoring, but it is also possible to decentralize the functions to a plurality of servers or devices. Also, the chain of processing from the collection of the path information and the traffic level and up to the group-specific mode instruction may operate at regular intervals, at time intervals designated by the network administrator.

Next, the structure and relationships of the various tables held by network monitoring server 301 will be explained. Network tree table 412 shown in FIG. 5 indicates various pieces of information about the network connection devices and the hierarchical relationships of the connections among the network connection devices. Network tree table 412 is a table consisting of: a host name column 501 storing the host names conferred on the network connection devices; an equipment summary column 502 storing equipment names, type numbers, and the like, of the network connection devices; a manufacturer column 503 storing the names of the manufacturers of the network connection devices; an IP address column 504 storing the IP addresses granted to the network connection devices; and a lower-level device column 505 and a higher-level device column 506 storing respectively host names of the network connection devices connected downstream and upstream from the network connection devices.

Business operation subdivision information table 403 shown in FIG. 6 is a table set in advance by the network administrator and is a table in which the business operation subdivisions and floors utilized on the occasion of grouping the network connection devices are stored. Business operation subdivision information table 403 is a table consisting of: a group ID column 601 for grouping and administering by business operation subdivision and installation floor; a business operation subdivision column 602 storing the business operation names or department names utilized by the network connection devices included in group ID column 601; and an installation floor column 603 storing the floors where the network connection devices and the business operations utilizing the network connection devices are situated. Further, in the present embodiment, the grouping is performed for each business operation subdivision of Company A, but by changing the values of business operation subdivision column 602, grouping with various subdivisions is possible.

Group-internal host information table 404 shown in FIG. 7 is a table which is set in advance by the network administrator and is a table administering the IP addresses allocated for each group. Group-internal host information table 404 consists of a group ID column 701 storing group IDs and a group-internal IP address range column 702 storing the ranges of IP addresses allocated for each group.

Group table 406 shown in FIG. 8 is generated, by means of group table generation part 405, by consulting network tree table 412, business operation subdivision information table 403, and group-internal host information table 404. Group table 406 administers hosts for each group, making it possible for network monitoring server 301, by using group table 406, to emit instructions to a plurality of network connection devices affiliated with the same group. Group table 406 is a table consisting of: a table ID column 801 storing group IDs; a configuration host column 802 storing the host names of network connection devices affiliated with the group; a business operation subdivision column 803 storing the business operation names and department names utilized by the network connection devices affiliated with the group; and an installation floor column 804 storing the floors on which the network connection devices and the business operation departments utilizing the network connection devices are installed.

Next, with reference to FIG. 5 to FIG. 7, there will be given an explanation regarding the procedure of generating group table 406 of FIG. 8. In the case of generating the group ID “A” record of group table 406, group ID “A” in group ID column 601 is first referenced from business operation subdivision information table 403, and the business operation subdivision “accounting and materials department” and the installation floor “2F” corresponding to group ID “A” are extracted from business operation subdivision column 602 and installation floor column 603, together with group ID “A”. A new record is generated in group table 406, storing Group ID “A”, the business operation subdivision “accounting and materials department”, and installation floor “2F”. Next, group ID column 701 and group-internal IP address range column 702 of group-internal host information table 404 are consulted and the IP address range “192.168.104.1-192.168.104.255” corresponding to group ID “A” is extracted.

Next, IP address column 504 of network tree table 412 is consulted. In case an IP address included in the range of the IP address range “192.168.104.1-192.168.104.255” is stored in IP address column 504, the corresponding host name of host name column 501 is extracted. In the case of the present embodiment, the host name “311” corresponds. The extracted host name “311” is stored in the newly generated group ID “A” record of group table 406. By repeating the aforementioned processing for each group ID, group table 406 is generated.

Next, an explanation will be given regarding group-specific traffic level table 409 shown in FIG. 9. Group-specific traffic level table 409 consists of group IDs 901, total traffic levels 902 of the network connection devices within the group, and threshold values 903 with respect to loads due to the communication traffic of the used group-specific network connection devices for utilization in the judgment as to whether to switch the group to the electric power conservation mode or release the electric power conservation mode. The threshold values need to be set in advance by the administrator. In the present embodiment, the total level of communication traffic of the network connection devices within each group is taken to be an indicator showing the load due to the communication traffic.

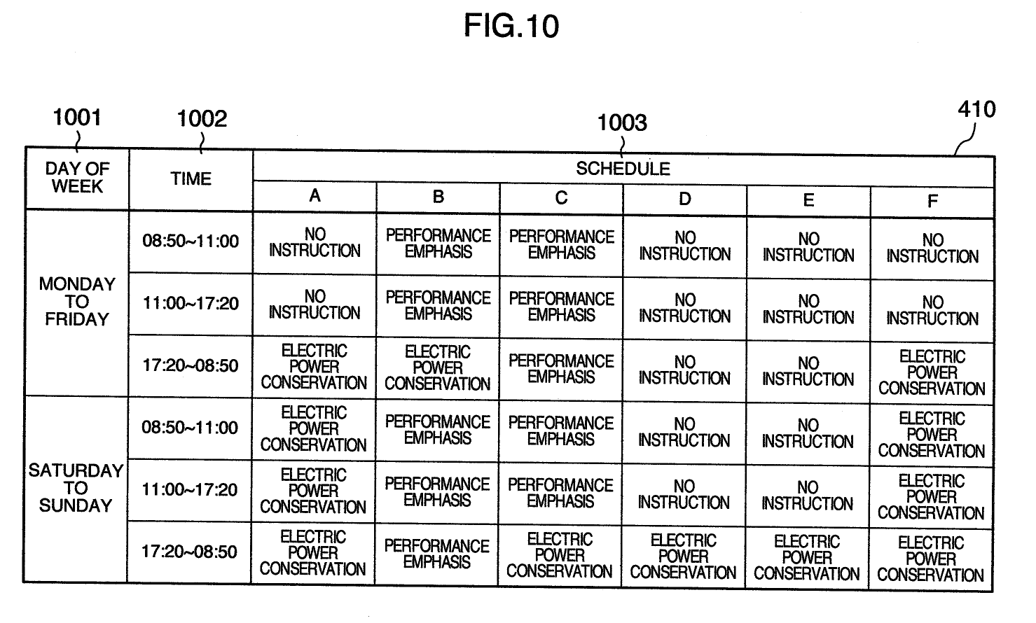

Next, an explanation will be given regarding time-of-day fixed instruction table 410 shown in FIG. 10. Time-of-day fixed instruction table 410 consists of a day-of-week column 1001 in which days of the week from Monday to Sunday are included; time column 1002 in which time slots are included; and group-specific schedule columns 1003 corresponding to days of the week in day-of-week column 1001 and time slots in time column 1002. In group-specific schedule columns 1003, there are stored instructions to each group. There are three types of instruction, “Performance Emphasis”, “Electric Power Conservation”, and “No Instruction”. In the case of “Performance Emphasis”, network monitoring server 301 requests operation that emphasizes performance over electric power consumption, with respect to the network connection devices. In the case of “Electric Power Conservation”, network monitoring server 301 requests operation that emphasizes restraints on electric power consumption over performance, with respect to the network connection devices. In the case of “No Instruction”, it does not perform fixed operation according to the time and the day of week but consults group-specific traffic level table 409 and, on the basis of total traffic levels 902 and threshold values 903, selects a performance emphasis mode or an electric power conservation mode. E.g., since the instruction with respect to Group B of the record for the “Monday to Friday” row of day-of-week column 1001 and the “11:00 AM-5:20 PM” time slot of time column 1002 is “Performance Emphasis”, network monitoring server 301 requests operation in the performance emphasis mode with respect to the host of Group B.

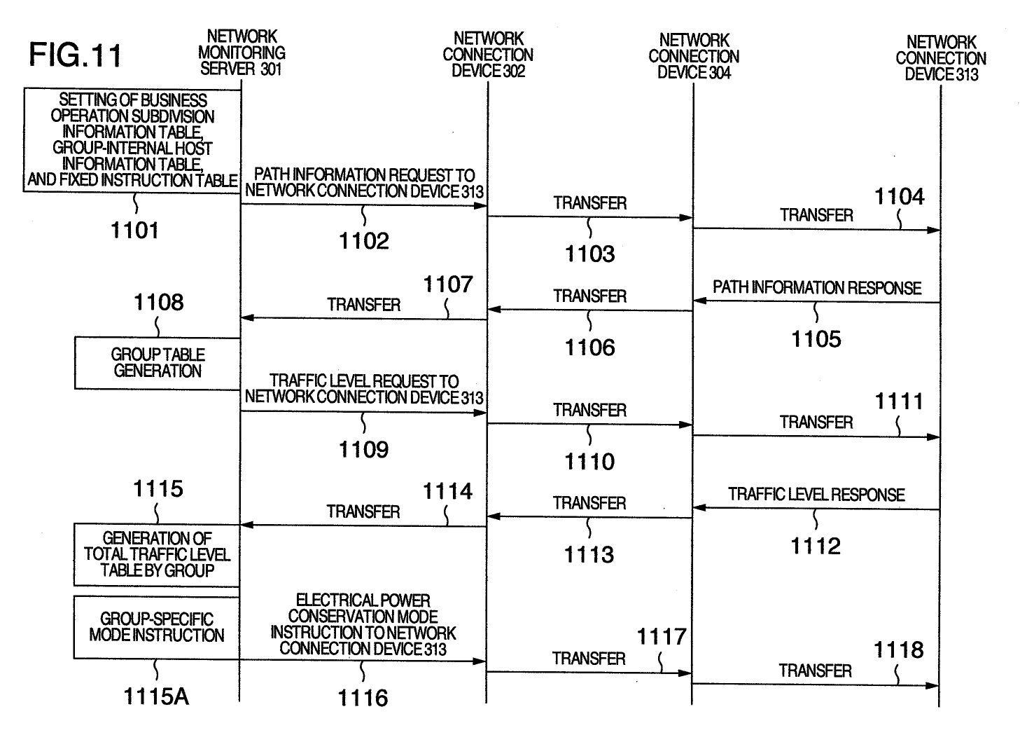

The sequence in which network monitoring server 301 collects information from the network connection devices in the network system and up to the point where it emits an instruction to switch operating modes is shown in FIG. 11. As an example, an explanation is given of the case in which an instruction is emitted with respect to Group “A”. First, the system administrator sets in advance business operation subdivision table 403, group-internal host information table 404, and time-of-day fixed instruction table 410 in network monitoring device 301 (Step 1101). Next, network monitoring server 301 requests path information from each network connection device under administration (Steps 1102 to 1104). The network connection devices respectively return the path information to network monitoring server 301 (Steps 1105 to 1107). Further, in the diagram, only the path information request message to network connection device 313 is represented, but requests are also carried out with respect to the other network connection devices. Also, the path information requests to each of the network connection devices need not be carried out simultaneously. Next, network monitoring server 301 generates group table 406 from business operation subdivision table 403, group-internal host information table 404, time-of-day fixed instruction table 410, and network tree table 412 generated from the collected path information (Step 1108).

Next, network monitoring server 301, using an snmpget command or the like, requests a traffic level response with respect to each network connection device, in order to examine the total traffic capacity for each group (Steps 1109 to 1111). The network connection devices respectively return traffic level responses to network monitoring server 301 (Steps 1112 to 1114). Further, in the diagram, only the traffic level response request message to network connection device 313 is represented, but traffic level response requests are also carried out with respect to the other network connection devices. Also, the traffic level response requests with respect to each of the network connection devices need not be carried out simultaneously. In addition, as the need arises, traffic level response requests may be carried out in units of groups. Next, group-specific traffic level table 409 is generated on the basis of the received traffic level information and group table 406 (Step 1115).

Next, group table 406, time-of-day fixed instruction information table 410, group-specific traffic level table 409 are consulted (1115A) and an instruction to switch to an electric power conservation mode is transmitted with respect to network connection device 313 affiliated with Group “A” (Steps 1116 to 1118). Further, in the diagram, there is only shown a mode switch instruction message to network connection device 313, but, as the need arises, mode switch instructions are carried out with respect to other network connection devices as well. Also, there is no need to carry out the mode switch instructions simultaneously with respect to each of the network connection devices. Network connection device 313, having received an instruction to switch to the electric power conservation mode, changes from an operating mode to the electric power conservation mode. For processing such as mode switch instructions, SNMP may be used, or another protocol may be used.

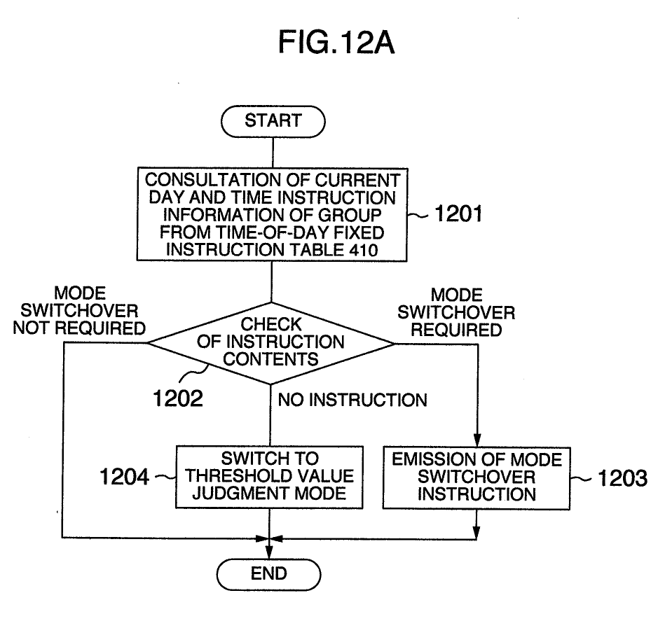

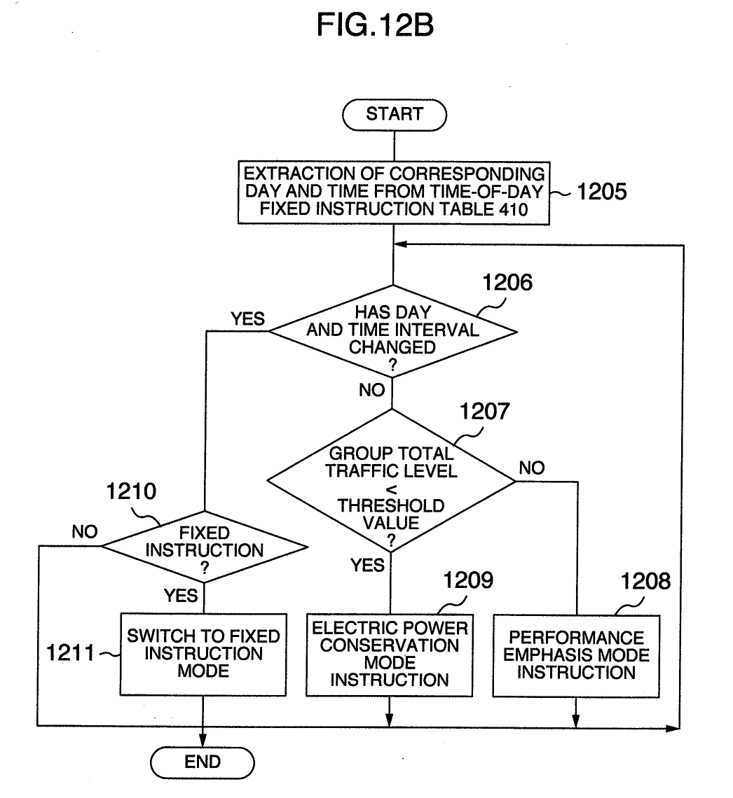

The internal processing of network monitoring server 301 up to the point where network monitoring server 301 emits an instruction to a network connection device is shown in FIGS. 12A and 12B. The fixed instruction mode shown in FIG. 12A is a mode in which mode switch instructions are transmitted to each of the network connection devices on the basis of time-of-day fixed instruction table 410. The threshold value judgment mode shown in FIG. 12B is a mode in which mode switch instructions are transmitted to each of the network connection devices on the basis of group-specific traffic level table 409.

Network monitoring server 301 starts operation in the fixed instruction mode. When the current time reaches the switchover timing position of the time slot stored in time column 1002 of time-of-day fixed instruction table 410, operation in the fixed instruction mode of FIG. 12A starts. E.g., in case the current time is “11:00 AM”, operation in the fixed instruction mode starts, since it is the timing position at which there is a switchover from the time slot “8:50 AM-11:00 AM” to the time slot “11:00 AM-5:20 PM” in time column 1002.

In the fixed instruction mode, group-specific mode instruction part 411 consults time-of-day fixed instruction table 410 (Step 1201). Next, the instruction mode of each group at the current day and time inside time-of-day fixed instruction table 410 is checked (Step 1202). For each group, a mode change instruction is emitted in case a mode change is required (Step 1203). E.g., in the case of Group “B”, there is a need to emit a mode switch instruction for day of week “Monday to Friday” when the time slot changes from “11:00 AM-5:20 PM” to “5:20 PM-8:50 AM” in time-of-day fixed instruction table 410, since the schedule changes from “Performance Emphasis” to “Electric Power Conservation”. In case there is no need for a mode change, the process reaches completion without any action. In case the schedule is at “No Instruction”, there is a switch to the threshold value judgment mode (Step 1204).

In the threshold value judgment mode, group-specific mode instruction part 411 extracts day and time information affiliated with the current time from time-of-day fixed instruction table 410 (Step 1205). E.g., in case the current day and time is Tuesday at 1:30 AM, the time slot “11:00 AM-5:20 PM” is extracted. This is because processing in the threshold value judgment mode is carried out during the time slot “11:00 AM-5:20 PM”.

Next, group-specific mode instruction part 411, to check whether the current time has changed day and time intervals, compares it with the extracted day and time information (Step 1206). E.g., if the threshold value judgment mode is entered at 1:30 PM on Tuesdays, the time slot “11:00 AM-5:20 PM” is extracted. Further, when time advances and the current time reaches 6:00 PM, the result is that the current time has changed from the time slot “11:00 AM-5:20 PM” to the interval of the timeslot “5:20 PM-8:50 AM”.

In case the date and time interval has not changed, since the current processing mode remains the threshold value judgment mode, group-specific mode instruction part 411 compares the current total traffic level of each group and the threshold value set for each group (Step 1207). In case the current total traffic level inside the group exceeds the threshold value, group-specific mode instruction part 411 emits an instruction to switch to the performance emphasis mode to the concerned group (Step 1208). Inversely, in the case where the current total traffic level inside the group is lower than the threshold value, group-specific mode instruction part 411 emits an instruction to switch to the electric power conservation mode to the concerned group (Step 1209). In either event, the process returns to Step 1206.

In case the date and time interval has changed, group-specific mode instruction part 411 checks whether the instructed mode in the time slot in time-of-day fixed instruction table 410 to which the change has been made is a fixed instruction “Performance Emphasis” or “Electric Power Conservation” (Step 1210). In case what is concerned is a fixed instruction, group-specific mode instruction part 411 switches to a fixed instruction mode and completes the threshold value judgment mode (Step 1211). In case what is concerned is not a fixed instruction (in the case of no instruction), group-specific mode instruction part 411 returns to Step 1206. Further, operation up to Steps 1201 to 1211 is carried out for each group but need not be carried out simultaneously.

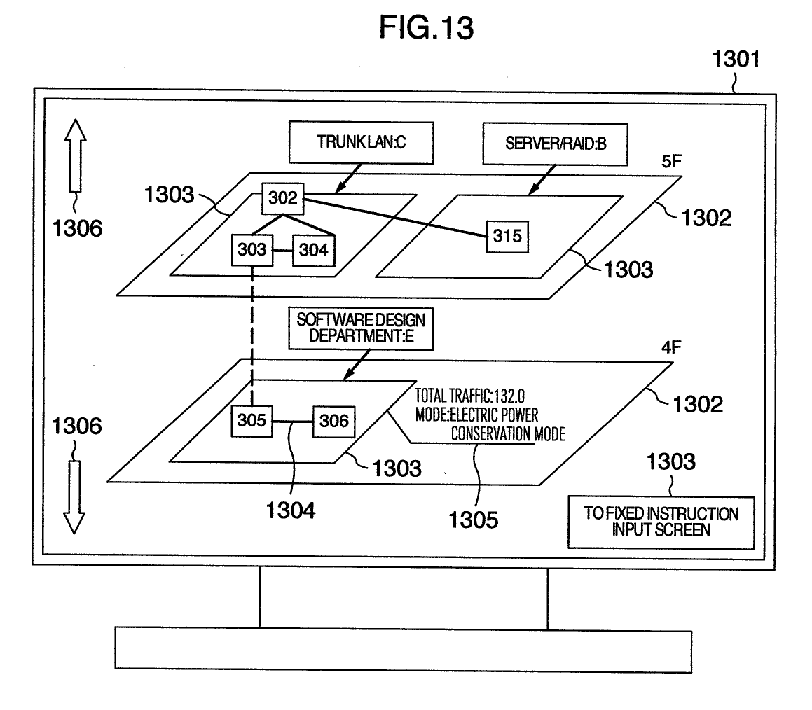

Next, an explanation will be given regarding a method of visually representing to the administrator, on a PC display or the like, information about the current traffic level, and whether the electric power conservation mode is active, about each of the network connection devices, by means of input output part 413 of network monitoring server 301, for each floor and business operation subdivision. An example of display contents is shown in FIG. 13. The display contents of the diagram represent the connection relationships of the network connection devices of floors “4F” and “5F”. First, each floor 1302 is represented on a display 1301. Further, the business operation subdivisions 1303 existing within each floor 1302 and the host(s) utilized within each of the same business operation subdivisions are displayed. And then, the connection relationships between each of the hosts are displayed. As for the connection relationships, they are displayed not only among the hosts within the same business operation subdivision, the connection relationships on entire floors or between hosts on different floors also being displayed. It is also possible to display only connection relationships within business operation subdivisions or only connection relationships within the same floor.

Also, for each business operation subdivision (group), there is carried out a display of a state 1305 of the current total traffic and information as to whether operation is performed in an electric power conservation mode. Regarding the display of state 1305, it is possible not to display other than necessary information. Also, in case there are too many floor layers or a floor is too large to fit inside the display, a scroll button 1306 is pushed, mouse scrolling is utilized, or a shortcut key on the keyboard is utilized to make the screen display the same.

The aforementioned display is displayed by consulting group table 406 and group-specific traffic level table 409. Also, by manipulating directly, by means of a mouse or the like, a model diagram of floors 1302 or business operation subdivisions 1303 represented visually on the display to the administrator, generation of a new business operation subdivision or a manipulation such as switching operating modes is carried out. In addition, it is also possible to move from a diagram display screen to a fixed instruction entry screen. Also, the system may be devised to make it possible to carry out direct fixed instruction entry on the diagram display screen.

According to the present embodiment, mentioned above, it is possible to set a switchover of operating modes all at once with respect to a plurality of network connection devices by grouping the same in logical units such as in business operation units or floor units, rather than in network connection device units. Also, in adapting to the actual situation of network use, operating mode switchovers, and the like, for each time slot such as “Within Regular Time” and “Outside Regular Time” become possible. Further, by measuring the actual traffic level of each group, operations such as switching to an electric power conservation mode during a time slot in which there are few data transfers in a certain group are possible.

Also, by visual representation, to the administrator, of the network system for each floor or business operation subdivision, administration becomes simple and intuitive manipulation also becomes possible.

Further, in the present embodiment, the network monitoring device may be represented as a monitoring device and the network connection devices as network devices. Also, host names may be represented as device identifiers and group IDs as group identifiers. Also, the business operation subdivision table, the group-internal host information table, the group table, and the time-of-day fixed instruction table may be simply represented as an Nth storage part. In addition, the group-specific traffic level computation part may be represented as a group-specific load level computation part.

It should be further understood by those skilled in the art that although the foregoing description has been made on embodiments of the invention, the invention is not limited thereto and various changes and modifications may be made without departing from the spirit of the invention and the scope of the appended claims.

1. A monitoring device connected with a plurality of network devices;
administering the aforementioned plurality of network devices by group; monitoring the level of communication traffic for each group; and
having a group-specific mode instruction part emitting, in units of the aforementioned groups, group-specific mode instructions to switch to an electric power conservation mode, to the aforementioned network devices.

2. The monitoring device according to claim 1, further having:
a path information extraction part acquiring, from said plurality of network devices, information including device identifiers uniquely identifying the respective aforementioned network devices; and
a first storage part in which the ranges of group identifiers uniquely identifying said groups and device identifiers corresponding to the concerned group identifiers are set in advance; and
generating a second storage part in which the correspondences between said group identifiers and said acquired device identifiers are stored by consulting the device identifiers acquired by said path information extraction part and said first storage part.

3. The monitoring device according to claim 2, wherein: said group-specific mode instruction part, in the case of emitting, in group units, an instruction to said network devices to switch to an electric power conservation mode, consults said second storage part, looks up said device identifiers corresponding to said group identifiers of groups which are to be switched to said electric power conservation mode; and emits an instruction to switch to the electric power conservation mode, to the network devices indicated by said looked-up device identifiers.

4. The monitoring device according to claim 3, further having a third storage part storing, for each time slot, instructions as to whether to make said network devices corresponding to said groups operate in an electric power conservation mode or not; consulting said third storage part by means of said group-specific mode instruction part; and, if there exist said groups for which an instruction is set to switch over to the electric power conservation mode at the current time, consulting said second storage part and emitting an instruction to switch to the electric power conservation mode, to said network devices corresponding to said groups for which an instruction to switch over to the electric power conservation mode is set.

5. The monitoring device according to claim 4, wherein: said third storage part stores information about the day of the week and, for each day of the week and further for each time slot, instructions as to whether to make said group operate in an electric power conservation mode or not; consults said third storage part by means of said group-specific mode instruction part; and, if there exist said groups for which an instruction is set to switch over to the electric power conservation mode, consults said second storage part and emits an instruction to switch to the electric power conservation mode, to said network devices corresponding to said groups for which an instruction to switch over to the electric power conservation mode is set.

6. The monitoring device according to claim 3, consulting said second storage part for each said group;
further having a traffic level extraction part acquiring information pertaining to the communication traffic level from said network devices
and a group-specific load computation part computing information pertaining to the communication traffic level acquired for each said group and the load due to communication traffic for each said group from said second storage part; judging, by means of said group-specific mode instruction part, whether said load is lower or not than a threshold value set in advance; and
emitting an instruction to switch to an electric power conservation mode to the network devices corresponding to the groups in which said load is lower than said threshold value.

7. The monitoring device according to claim 3,
having a traffic level extraction part acquiring information pertaining to the communication traffic level from said network devices
and a group-specific load level computation part computing the load due to communication traffic for each said group from information pertaining to the acquired communication traffic level and said second storage part;
having a third storage part storing instructions as to whether to make said groups operate in an electric power conservation mode or not for each time slot; consulting said third storage part by means of said group-specific mode instruction part; and, if there exist said groups for which an instruction is set to switch over to an electric power conservation mode at the current time, consulting said second storage part and emitting an instruction to switch to an electric power conservation mode to said network devices corresponding to said groups; and,
in the case of emitting an instruction to said groups for which there exist time slots in which said instruction is not set in said third storage part: during the time slots in which said instruction is set, consulting said third storage part by means of said group-specific mode instruction part, consulting said second storage part, and emitting an instruction to switch to an electric power conservation mode to said network devices corresponding to said groups; and, during the time slots in which said instruction is not set, consulting said second storage part for each said group by means of said group-specific mode instruction part, judging whether said load is lower or not than the threshold value set in advance, and, in case said load is lower than said threshold value, emitting an instruction to switch to an electric power conservation mode to the network devices corresponding to said groups.

8. The monitoring device according to claim 7, wherein said third storage part stores information about the day of the week and, for each day of the week and further for each time slot, instructions as to whether to make said group operate in an electric power conservation mode or not;
consults said third storage part by means of said group-specific mode instruction part; and, if there exist said groups for which an instruction is set to switch over to the electric power conservation mode, consults said second storage part and emits an instruction to switch to the electric power conservation mode, to said network devices corresponding to said groups for which an instruction to switch over to the electric power conservation mode is set.

9. The monitoring device according to claim 2, further having a fourth storage device for storing said group identifiers, business operation subdivisions in which the network devices corresponding to said group identifiers are utilized, a correspondences of the installation floors on which the network devices corresponding to said group identifiers are installed; and, at the time of generating said storage part, storing in said second storage part the correspondences of said group identifiers, said network devices, said business operation subdivisions, and said installation floors, by consulting said fourth storage part.

10. The monitoring device according to claim 9, further having a display part consulting said second storage part and visually representing on the display of an administrator terminal said grouped network connection relationships of said network devices and network connection relationships between groups for each said installation floor, or for each said business operation subdivision, or for each said installation floor and further for each said business operation subdivision.

11. The monitoring device according to claim 10, wherein said display part, in the case where the number of said installation floor levels is too great to make it possible to display on said display screen, further has a button for making said display scroll the screen of said display.

12. The monitoring device according to claim 10, wherein said display part, in the case where the number of said installation floor levels is too great to make it possible to display on said display screen, scroll displays the screen of said display by making the mouse of said administrator terminal scroll.

13. The monitoring device according to claim 10, wherein said display part displays, on the screen of said display, the load due to the communication traffic of said group corresponding to said business operation subdivision, for each said business operation subdivision.

14. The monitoring device according to claim 10, wherein said display part displays, on the screen of said display, whether said group corresponding to said business operation subdivision is operating in an electric power conservation mode or not, for each said business operation subdivision.
